(19) United States
(12) Patent Application Publication
(10) Pub. No.: US 2003/0233547 A1
(43) Pub. Date: Dec. 18, 2003

(54) Systems and methods for preventing and detecting unauthorized copying of software

(75) Inventors: Kerry R. Gaston, Montgomery, AL (US); Bradley D. Hawkins, Montgomery, AL (US); Jason P. Ramsey, Montgomery, AL (US); James S. White, Montgomery, AL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Global Anti-Piracy Systems, Inc., Montgomery, AL (US)

(21) Appl. No.: 10/324,743

(22) Filed: Dec. 19, 2002

Related U.S. Application Data
(63) Continuation-in-part of application No. 09/963,646, filed on Sep. 25, 2001.

(51) Int. Cl. H04L 9/00

(52) U.S. Cl. 713/168

(57) ABSTRACT

The present invention is a method and system for preventing and/or tracking unauthorized copying or distribution of downloaded software. In general, the software is tagged with user identifying and/or platform-identifying information, preferably in coded form, both to allow a validation check to determine whether a particular platform is authorized and to trace a pirated copy to its original authorized user. The platform-identifying information is preferably placed in numerous locations, some of which may be used for the validation check, others of which may not be. In addition, other information usable to identify an original user or purchaser may be embedded within the material of interest. Several alternative methods of tagging the software may be used depending upon whether the particular portion being tagged comprises executable or non-executable content.

### REFERENCE TO RELATED APPLICATION

This application is related to like-titled pending U.S. patent application Ser. No. 09/963,646 by Kerry R. Gaston, Bradley D. Hawkins, and James S. White filed on Sep. 25, 2001, as a continuation-in-part thereof. The whole of that application is incorporated herein in its entirety by reference for all of its teachings without limitation.

### TECHNICAL FIELD OF THE INVENTION

This invention relates generally to systems and methods for preventing the piracy of computer software, such as executable content, nonexecutable content or combos thereof, and more particularly to systems and methods for preventing the unauthorized distribution of such software downloaded over a distributed network.

### BACKGROUND

Downloading software over the Internet provides software developers with a cost-effective alternative for distributing their products. Instead of recording their software product onto a magnetic media, such as a diskette, or onto an optical media, such as a compact disk (“CD”), software developers can simply place their software on a web site and allow users to download the software program directly onto their computer.

After the user has selected and paid for the software application program, the user will typically accept a “click wrap” license agreement by selecting an “I Agree” button, or some similar button, at the end of the license agreement. Typically, the license agreement limits the user to install the software on a single computer and prohibits the user from distributing the software application program to anyone else. These license agreements are known as single-user licensing agreements and are generally meant for the typical consumer.

Fortunately, the majority of people who purchase software application programs and other software products over the Internet, respect the license agreement and use the software in accordance with the license agreement. Unfortunately, for one reason or another, many people do not respect the terms of the licensing agreement. For example, “computer hackers” disregard the license agreement and freely distribute unauthorized copies of the software product once they have downloaded it from the Internet. Alternatively, the hacker may be financially motivated to sell the unauthorized pirated copies of the product to others. The hacker may not receive any financial gain, but nonetheless may be motivated to freely distribute the software product, such as by uploading the product onto a USENET server from which any computer user can freely access and download the program without paying for it. The distribution of the software may be less malevolent, such as when a child computer user who may not fully comprehend the terms of the agreement distributes several unauthorized copies to his friends. Regardless of the reason, software piracy imposes a substantial cost on the software developer. However, there is currently no effective way for the software developer to monitor whether users are complying with the license agreement.

Several anti-piracy software methods involve checking validation of the software application program by accessing a database on a central server over a distributed network, such as the Internet. In one method, if the software application program does not have a valid license, the software application program is disabled. In another method the number of registered copies of a software application program running on a network is tracked. Each time a copy of the software application program is executed a counter is incremented and checked against a central database that contains an indication of the number of allowed licenses for that software application program. If the counter does not exceed the number of allowed licenses, the software application program is executed over the network. If, however, the counter exceeds the number of allowed licenses stored in the central server, then the execution of the software application program is terminated. Each of these methods has several limitations. First, each method is limited to software applications running on a distributed network. The method only checks to insure that the software program running on the network has a valid license. There is no way to check for software application programs that run independently on stand-alone computer for valid licenses. Furthermore, there is no way for these methods to track any unauthorized copies of the software program back to the user who distributed the unauthorized software copies.

Thus, there is a need in the art for methods and systems that prevent the unauthorized distribution of software including application programs. There is a further need in the art for methods and systems for tracking the distribution of unauthorized copies of software in the event that a hacker is able to distribute the unauthorized copies of the software application program. Being able to trace each unauthorized copy back to the individual who distributed that copy allows the distributing individual to be charged and/or fined in accordance with the law.

### SUMMARY OF THE INVENTION

The invention addresses the problems above and others by providing methods and systems for preventing unauthorized distribution of software application programs and other software that are downloaded over a distributed network. Generally described, the invention is a method that substantially prevents, or detects after the fact, the distribution of unauthorized copies of software, e.g. executable content, media content, etc., in violation of the license agreement and/or applicable law. The method begins when a user first purchases this software for downloading to their computer from an application server platform. Once the user purchases the software and agrees to the license agreement where appropriate, an installation program, also known as a “Client Program” or stub, is first downloaded from the application server platform to the user's computer over a non-secured communications channel. Next, the user's computer executes the Client Program, which in turn contacts the server platform and establishes a second communications channel with the server platform. The Client Program also scans the user's computer system to determine the identification numbers of various components installed on the user's computer, including hardware and software elements. For example, the identification numbers may be the class identifiers associated with each hardware driver for each component installed on the user's machine or identification information associated with an operating system or other component, although the invention is not limited to such.

The Client Program or stub then either uses these identifiers to generate, or instead causes to be generated from these identifiers, a unique user identifier (“UUI”) code that is statistically unique to the user's machine. The Client Program then transmits the UUI (or the platform information if the Client Program does not itself generate the UUI) over the encrypted communications channel to the server platform, where the UUI may be generated if it has not already been and may be segmented and dispersed within the files associated with the software application program. The desired content, e.g. the files corresponding to the software, are downloaded to the user's computer and preferably are installed at various locations throughout the hard drive of the user's computer.

For executable content, each time the software is executed, an anti-piracy check is also run to determine whether the UUI of the user's machine matches the UUI embedded in the files of the software application program. If the UUI of the user's machine does not match the UUI embedded within one or more of the software's files, the execution of the software program terminates. If, however, the UUI of the machine matches the UUI embedded within the files, the software application program will execute normally and the user will never know that the anti-piracy check was performed. Note that the UUI, or additionally or alternatively other user-identifying information such as credit card number, look-up number, etc. associated at the time of sale with the purchaser, may be dispersed in one or more places in the material of interest to facilitate later tracing if the validation check is overcome. Other advantages and features of the invention will be apparent from the description below, and from the accompanying papers forming this application.

### BRIEF DESCRIPTION OF DRAWINGS

The accompanying drawings, which are incorporated in and form a part of the specification, illustrate preferred embodiments of the present invention and, together with the description, disclose the principles of the invention.

FIG. 1 is a block diagram of a prior art method for downloading computer software over a distributed network;

FIG. 2 is a block diagram of a method of downloading computer software over the Internet to prevent unauthorized copying of the computer software according to an embodiment of the invention;

FIG. 3 is a block diagram of a method of tracking the unauthorized distribution of computer software using an embodiment of the invention;

FIGS. 4A-C, hereinafter collectively referred to as FIG. 4, are logic flow diagrams illustrating a method for downloading computer software over the Internet using an embodiment of the invention;

FIGS. 5A-C are schematic diagrams illustrating in greater detail the tagging of a non-executable file such as an image file according to an embodiment of the invention;

FIG. 6A is a flow chart illustrating a technique for tagging nonexecutable content for both machine validation and piracy traceability according to an embodiment of the invention; and

FIG. 6B is a flow chart illustrating a technique for accessing tagged nonexecutable content according to an embodiment of the invention.

### DETAILED DESCRIPTION

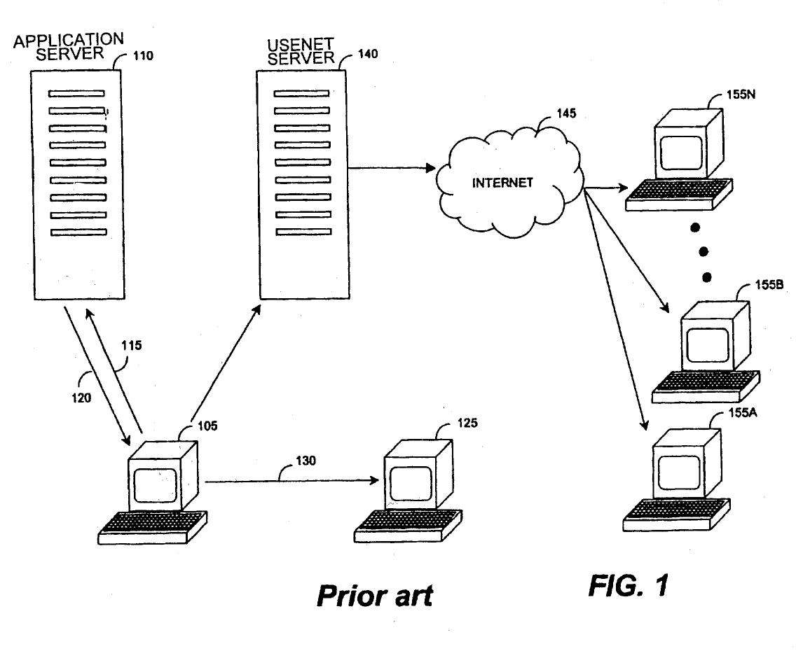

FIG. 1 is a block diagram illustrating a prior art method of downloading a software application program from the Internet and allowing for the unauthorized distribution of the downloaded software. To download a software application program over the Internet, an authorized user, through his or her computer 105, accesses a remote server 110 over a first communications channel 115 of a distributed network, such as the Internet, where the software application program is located. Typically, the first communications channel 115 will be a non-secured communications channel because no sensitive information is being transmitted between the server platform and the client platform. However, the software application program is typically downloaded over a second communications channel 120 to the authorized user's client platform 105. Typically, the second communications channel is a secured channel to minimize the possibility of “hackers” tapping the communications link and illegally obtaining the application program. The files associated with the software application program may be compressed into a single file, known as a “zip” file, to reduce space and downloading time. Once the computer program is successfully downloaded to the user's client platform 105, the application program is installed. At this point most users will use the software application program in accordance with the license agreement. That is, they will only use the software application program on one machine. However, there are some authorized users that willingly violate the software license agreement by distributing unauthorized copies of the software application program to an unauthorized user who installs it on an unauthorized platform 125. As an example, a teenage user may legally download a computer game from a remote server after agreeing to the licensing agreement, which prohibits distributing the software to third parties. However, after playing the computer game, the teenage user makes a copy of the downloaded computer game and distributes it to his friends. Unfortunately, by making a copy of the downloaded computer game and distributing it to his friends, the teenage user has violated the software license agreement and more importantly, the manufacturer of the computer game has lost a potential sale. Furthermore, the manufacturer of the software game has no way to track to whom the teenage user has distributed unauthorized copies.

A more serious instance of distributing unauthorized copies of software occurs when the authorized user uploads the software application program to a remote server, such as a USENET server 140, which is accessible to everyone on the Internet. Once the software application program is uploaded to USENET server 140, it can be freely accessed as an Internet software download 145 by any unauthorized users (155A, 155B, . . . 155N) attached to the Internet. In this manner, the software application program can be distributed to an unlimited number of unauthorized users, which can result in untold losses to the software manufacturer.

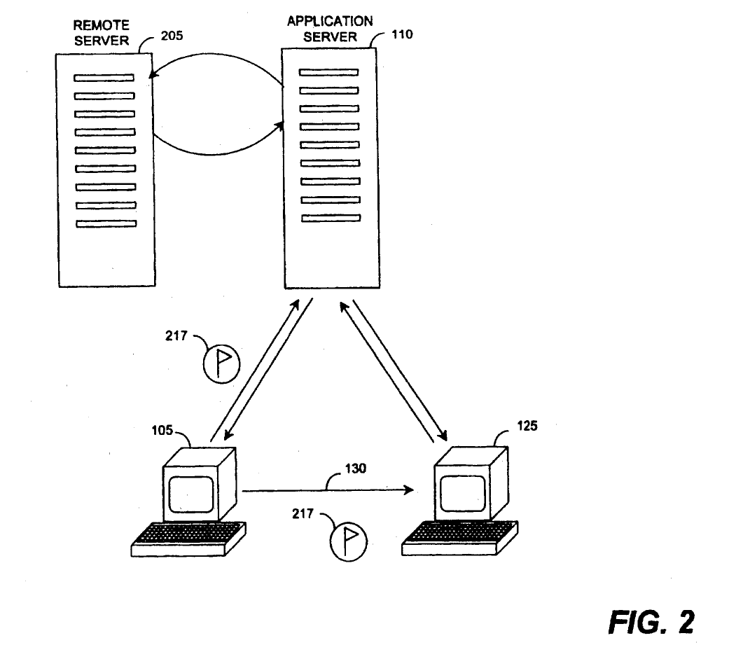

Reference will now be made in detail to various embodiments of the invention, non-limiting examples of which are illustrated in the accompanying drawings. FIG. 2 is a block diagram illustrating a distributed network for downloading a software application program over a distributed network in accordance with the present invention. The software application program is stored on an application server 110. The process begins when a user purchases the software application program by accessing the application server 110 from a client platform 105, over the distributed network. Typically, the client platform 105 will be a personal computer, however, those skilled in the art will appreciate that other devices, such as personal digital assistants (PDAs), cellular telephone devices, pagers, MP3 players, electronic books, game platforms and the like may be used as the personal platform 105. Generally before installing the software, the authorized user must agree to a “click-wrap” software license agreement, which typically limits the manner and/or extent to which the user may load and execute the software. Once the user has purchased executable content, a software application program referred to as a Client Program or stub is downloaded from a server into a client platform memory, such as a client platform hard drive. The purchase of the software is recorded on a remote server 205 along with user-identifying indicia directly or indirectly associated with the particular stub or Client Program for registration purposes.

The Client Program, which automatically installs itself on the client platform 105, is then manually or automatically executed once it has been completely downloaded and installed. Once the Client Program has been executed, the Client Program automatically generates (or causes to generated, such as by the application server or other remote machine, as discussed above) a UUI 217 that is unique to the client platform 105. It will be appreciated from the following that uniqueness of the user identifier is extremely likely, but is not absolutely necessary or guaranteed in every embodiment. To initiate the creation of the UUI 217, the Client Program first retrieves identifying indicia from the client platform. Normally, the identifying indicia may be the globally unique identifiers (GUIDs) of each device installed on the client platform 105, the network interface card media access control (NIC MAC), the ID of the hard drive, the LBA of every immoveable file installed on the client platform 105, or any other identifiers attached to the client platform 105 such as an operating system instance identifier or other software identifiers.

In an embodiment of the invention, the Client Program considers the identifying indicia in a predetermined order. In an embodiment of the invention, the Client Program retrieves in sequence the GUID for each device attached to the client platform, the NIC MAC, the hard drive ID, and the immoveable files LBA. The unique identifiers for elements associated with each client computer will vary from client platform to client platform. This provides an advantage in that each UUI 217 will be distinctive of the particular client platform 105. However, the Client Program need not use all available indicia, and may include a single identifying indicial or as many identifying indicia as requested by the software manufacturer. Additional security may be added by including a unique customer identification number and/or unique BIOS information from the client platform 105.

The Client Program then establishes an encrypted communications channel 120 with the application server 110. The Client Program then uploads the UUI 217 (or platform information) to the application server 110 over the encrypted communications channel 120. An encrypted channel 120 is used to reduce the risk that “hackers” will steal the uploaded information. As noted earlier, in an alternative embodiment of the invention, the server 110 or other remote machine receives the raw platform specific information and subsequently derives the UUI from that information. In addition to the UUI or platform information, the identifying indicia associated with the Client Program are uploaded to the application server 110, which in turn transmits the identifying indicia to the remote server 205. The identifying indicia are compared to a database to determine whether, or how many times, the particular Client Program has been activated for download, i.e. whether a predetermined number of downloads has been met already.

If the determination is made that the Client Program has not been previously executed for download, or in the case of multiple allowed downloads has not been executed more than a predetermined number of times for download, then the downloading of the software is allowed to proceed via a first command sent back to the application server indicating that the Client Program has not yet been previously executed its authorized number of times. A flag is then set in the database indicating that that particular Client Program has been executed, or a counter is incremented in the case of multiple allowed downloads. If, however, the determination is made that the Client Program has already been previously executed its allowed number of times, a second command is transmitted to the application server 205 which “locks out” the relevant desired software and prohibits further download of the software from the application server 110 to the client platform 105. Once the determination is made that the Client Program has not been previously executed for download its allotted amount of times, the platform information may then be passed to a control program for further processing, such as segmentation etc., if desired.

After the UUI is processed, each segment, or the entire UUI if appropriate, may replicated multiple times in the software material of interest, in either one or both of executable content and media content as described in greater detail later. Additionally or alternatively, other user-identifying information usable for tracing the purchaser or purchaser platform or other material or item associated with the purchaser may be embedded in the software of interest. The precise number of times the UUI or each segment thereof, or other tag information (collectively “tag”), is replicated is not critical and can be determined by the software manufacturer. For instance, one software manufacturer may distribute a fairly small and inexpensive program that they feel will not be widely pirated and require that the tag is replicated twice. Contrarily, another software manufacturer may distribute a costly and complex program that they fear may be widely copied. In this instance the manufacturer may request that the tag be replicated 10 times to assure themselves that a “hacker” will not be able to eliminate each instance of the tag and freely distribute unauthorized copies of the software application program. Allowing each manufacturer to set the number of times that traceable identifying information is replicated insures that each manufacturer obtains the level of security they believe is necessary to stop the unauthorized distribution of their software application programs without introducing excess complexity. The replicated tags are then embedded throughout the software of interest.

Each file of the software of interest is then downloaded over the encrypted channel 120 and installed in different locations on the client platform's memory storage device. For example, if the client platform 105 is a personal computer, the memory storage device will typically be a hard drive. If, however, the client platform 105 is a smaller device such as the PDA, web enabled cellular telephone, or audio player mentioned previously, the memory storage device may be a memory card. In an embodiment of the invention, the file or files associated with the software of interest may be placed in a single contiguous location in the platform 105 memory.

Once all the files of the relevant software have been placed in the memory storage device of the client platform 105, the software application program is ready to be executed by the authorized user. For executable content, the software application program launches the Client Program each time the application is executed. This is accomplished via a code check step inserted into one or more of the relevant file or files as discussed in greater detail hereinafter. The Client Program then determines the UUI 217 of the executing client platform 105 and checks it against the UUI 217 information embedded within the relevant software application program files. If the UUI 217 of the client platform 105 matches the UUI 217 embedded within the relevant software application program, the software application program executes in the usual manner without the user being made aware that the UUI 217 was checked. If, however, the UUI 217 of the client platform 105 does not match the UUI 217 embedded in the software application program, the Client Program prevents the software application program from executing. In this manner, execution of unauthorized copies of protected applications is effectively prevented. In addition, the code check may also transmit a notification of unauthorized access to authorities or another interested party such as a manufacturer, and/or present a notice to a user of the executing platform warning against unauthorized use. Moreover, an advertisement or other commercial or informational material may be exhibited or played, such as to induce the user to make an authorized purchase of the content of interest.

As an example, suppose that an authorized user attempts to give an unauthorized copy of the software application program to a friend who is an unauthorized user, by transmitting the Client Program from the client platform 105 to the unauthorized user's platform 125 over a communications link 130 and the unauthorized user attempts to run the Client Program. The Client Program will contact the application server 110, and transmit the machine's UUI 217 and the identifying indicia associated with the Client Program. The application server 110, in turn transmits the identifying indicia associated with the Client Program to the remote server, where it is checked against the database. Since the Client Program has been previously executed by the authorized user, the remote sever 205 will transmit the second command back to the application server 110, which prevents the software application from being downloaded to the unauthorized user's platform 125.

The invention can also prevent the unauthorized use of copies even when the download step is circumvented. For example, if the authorized user is an experienced hacker and has experience with pirating software, the authorized user may be able to locate all of the files installed and used by the software application program. If the authorized user is able to locate each file, the authorized user may then be able to bundle the files into a single file that he may distribute to any number of unauthorized users. However, even after an unauthorized user downloads this single file and manages to correctly install it on their platform 125, the unauthorized copies of the software will still not work. This is because the unauthorized user's platform 125 would have a different UUI 217. Thus, when the Client Program calculates the UUI of the unauthorized user's platform 125 and compares it to the UUI 217 embedded throughout the files of the software application program, the two UUI's 217 would not match and the Client Program would terminate the execution of the software application program.

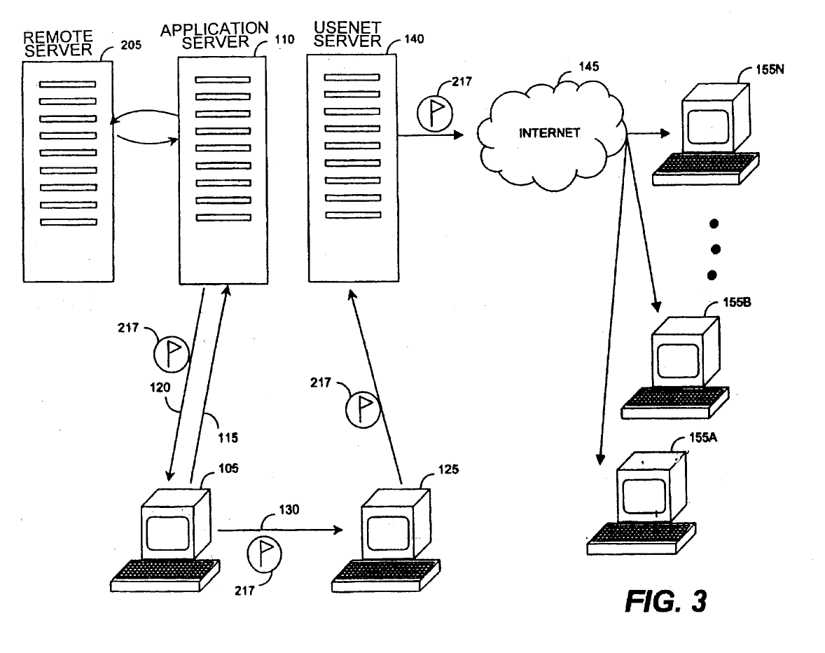

FIG. 3 is a block diagram illustrating the method of tracking unauthorized copies of the protected software content. For example, an authorized user downloads an authorized copy of a software application program from the application server 110 to a client platform 105 as described above. The software application program has multiple instances of the UUI 217 embedded within its files and is lawfully installed on the client platform 105 in accordance with the license agreement. Suppose however, that the authorized user is an exceptionally talented hacker and is able to decompile the software application program executable and examine the encoded data to determine where within the files the UUI 217 is checked against the UUI 217 of the host platform. The hacker then deletes the UUI checks so that when the software application program is executed, the UUI checks are no longer performed. The hacker then believes that he or she can distribute unauthorized copies of the software application program to unauthorized user platforms 125 through the communications channel 130. The easiest method of distributing pirated software is for the hacker to make CD copies of the software application program and give the CDs to his or her friends. Alternatively, on a broader and more egregious scale, the authorized user could post the software application program to a USENET server 140 so that any user operating a platform (155A, 155B, . . . 155N) with a connection to the Internet 145 could have access to the software application program. Any user (155A, 155B, . . . 155N) could download the pirated version of the software application program over the Internet 145 and run it uninhibited on their computer.

However, unknown to the authorized user is that multiple instances of the UUI 217 or other tag information, typically derived from the authorized user's client platform 105, or other material or item associated with the user such as credit card number or purchase look-up number, are embedded within the files of the software application program. Because the tag information is embedded in locations within the files that are not used to check to determine whether the software application program is pirated, the hacker is unaware that the tag information is transmitted with each copy of the pirated software. Therefore, by embedding multiple instances of the tag information within the files of the software application program, unauthorized copies of the software application program can be tracked so that the unauthorized users can be arrested, fined, etc. under the appropriate legal provisions.

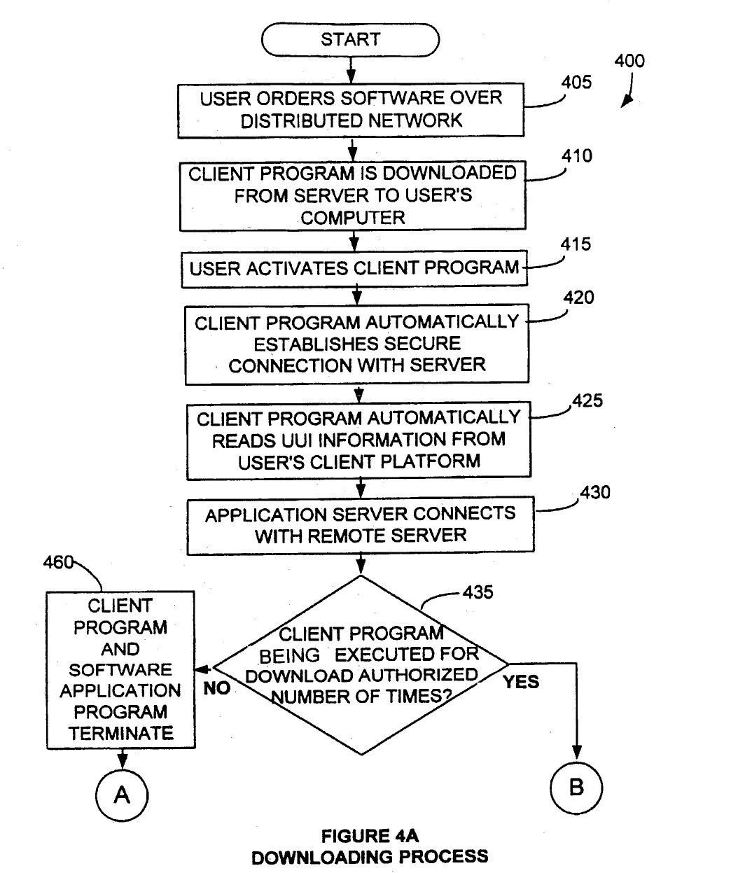

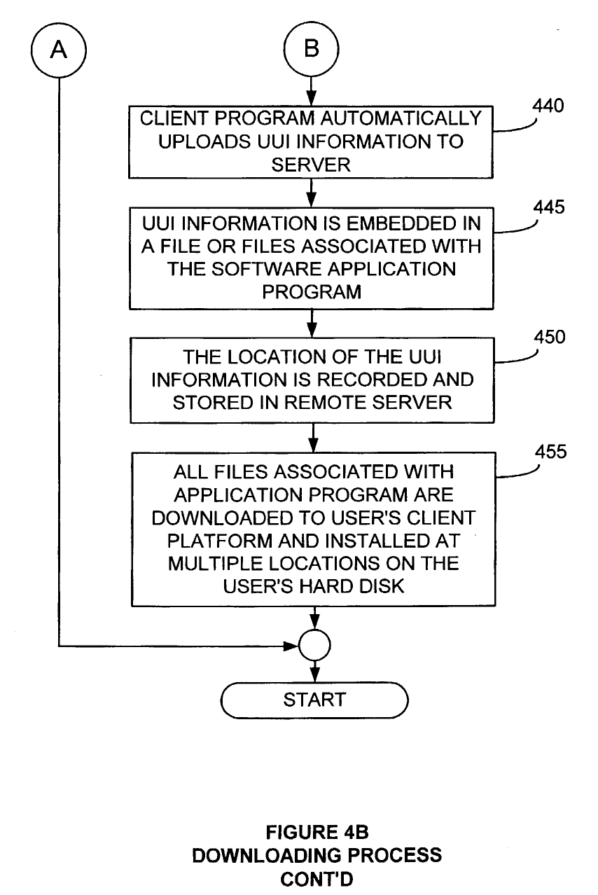

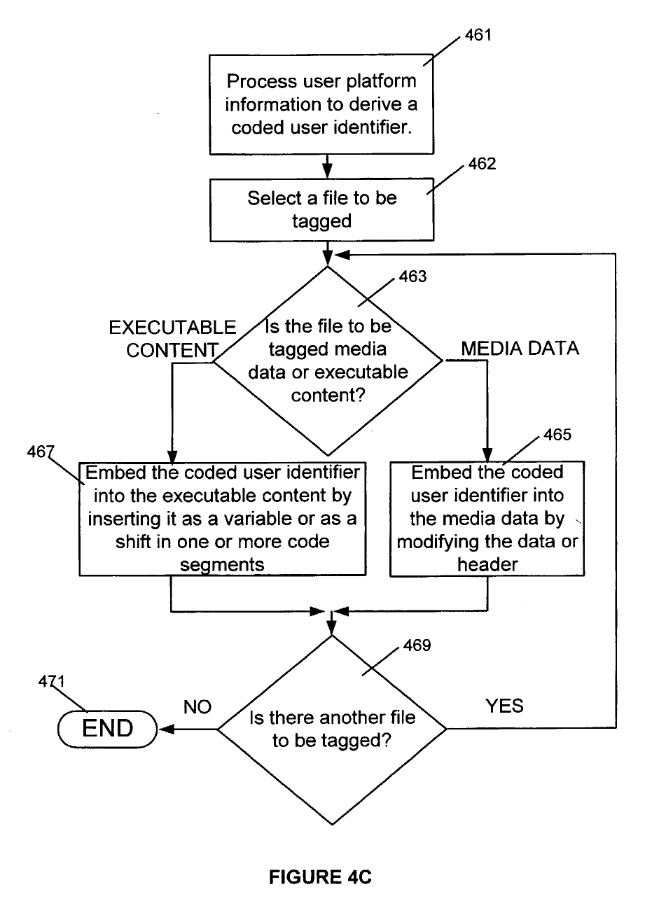

FIGS. 4A and 4B are logical flow diagrams illustrating a routine 400 for downloading a software application program over the Internet using the present invention. The routine 400 begins at step 405, in which the user purchases the software application program from a vendor over a distributed network, such as the Internet. The user must establish a connection with an appropriate application server, which stores the desired software application program. In purchasing the software application program, the user typically agrees to a “click wrap” license agreement, which normally states that the user will only install and run the software application program on a single platform.

At step 410, typically executed during installation, a Client Program is downloaded from the application server to the user's client platform. Normally the client platform will be a personal computer. However, the client platform may be a PDA, a web-enabled cellular telephone, or any other device capable of storing and executing a software application program.

Step 410 is followed by step 415, in which the user executes the Client Program, which automatically installs itself on the client platform. Alternatively, the Client Program may be a self-executing program, which preferably automatically executes once it is downloaded onto the client platform as discussed above.

Step 415 is then followed by step 420, in which the Client Program automatically establishes a secure communications link with the application server. The secure communications link is typically an encrypted channel, which ensures that hackers cannot pilfer the UUI as it is uploaded to the application server.

Next, step 420 is followed by step 425, in which the Client Program automatically causes to be generated the UUI that is unique to the client platform by retrieving identifying indicia from the client platform. As discussed, the Client Program either generates the UUI itself or causes another entity such as at the remote server to generate the UUI. As discussed above, the identifying indicia may be hardware or software identifying information, such as the global unique identifications (GUIDs) of each device installed on the client platform, the (NIC MAC), the ID of the hard drive, the LBA of immoveable files installed on the client platform, an operating system identifier, or any other identifiers attached to the client platform as discussed above. The exact manner of representing the identifying indicia in a UUI in accordance with embodiments of the invention is not critical, and may be accomplished in any manner suitable for the particular implementation.

Step 425 is followed by step 430, in which the application server connects with a remote server. The remote server contains a database that stores the client platform's UUI along with an indication of whether, or in some embodiments the number of times, the Client Program has been previously executed for download.

Step 430 is followed by step 435, in which the determination is made whether the Client Program is being executed for download the first time or for a subsequent authorized download. As discussed above, a unique identifier associated with the Client Program is stored in the database on the remote server. Typically, for single authorized download the unique identifier is associated with a flag that is set when the Client Program is executed for download, while for multiple authorized downloads the unique identifier is associated with a counter that is incremented when the Client Program is executed for download. If the flag has not been set, or if the counter has not been incremented to the maximum number of allowed downloads, then the Client Program has not been previously executed for download its authorized number of times and the “YES” branch is followed to step 440, in which the Client Program automatically uploads the UUI to the application server over the encrypted channel. Note that in the case that the software has already been installed on the particular target machine, the UUI is matched against the previous install computer's UUI. If they are equal, installation continues, if not, it terminates.

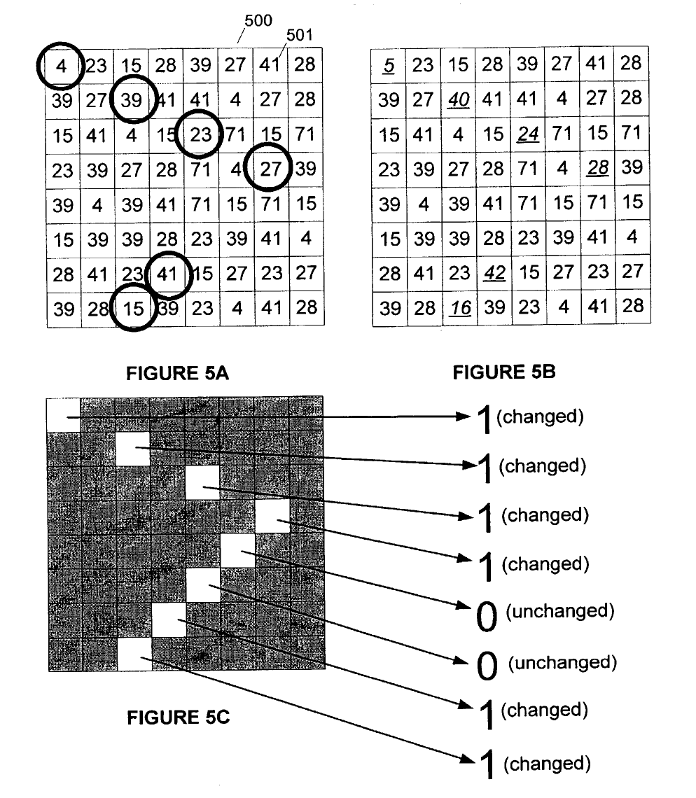

Next, routine 400 proceeds to step 445, in which the UUI information is embedded within one or more files associated with the software material of interest. The UUI may in an embodiment first be coded prior to insertion into the material to be protected, such as by MD5 hashing of the string corresponding to the UUI, and in a further embodiment may be segmented, such as into several 16-bit words. A representation of the UUI, either in unitary form or in pieces, is then replicated multiple times and embedded into one or more files associated with the software of interest. The additional tags may, as discussed, consist of other user or platform identifying information such as purchase look-up number, credit card number, etc. The type of file may determine the technique chosen to embed the tag information into the file. For example, for executable files, the tag information can be embedded within a string placeholder. Media files, such as image files etc., on the other hand, may be subtly altered to include the tag information in the pixel or sample data. Alternatively, the tag information can be embedded into a header of the media file. FIG. 5, to be discussed shortly, illustrates in graphical form the first approach to tagging media files. It is at step 445 as well, in an embodiment of the invention, that a code check as described above is embedded into the materials of interest. As discussed above, it is preferable that there exist one or more tags that are not associated with or referred to by the code check, so that such tags may be more difficult to locate and extract.

Step 445 is followed by step 450, in which the UUI information is recorded and stored in the database at the remote server. In addition to the UUI information, the location of each instance of tag information in whole or in part is also stored in the database. This ensures that the identity of the first authorized user can be determined in the case that a hacker successfully deletes any UUI checks so that they are no longer performed when the software application program is executed as discussed above.

Since the UUI or other tag information is not known beforehand for every given software copy, such as a suspected pirated copy, it is preferable that the embedded tag information is independently locatable without such knowledge. Accordingly, in an embodiment of the invention, the tag information is placed in the same location for every instance of a particular software item such as an executable file or files or media content. In addition or alternatively, the embedded tag information may be associated with searchable characters or strings for ease of location. In any case, it is preferable that the particular searchable items or predetermined locations not be made generally known, so that tags will not be easily locatable and removable by anyone other than authorized parties such as the manufacturer, seller, etc.

Knowing the location of tag information in the software allows the software manufacturer to compare the files of the suspected unauthorized copy of the software application program with the known locations of the tag information to determine whether the suspected unauthorized copy of the software application program has been pirated. Additionally, checking the files of the suspected unauthorized copy of the software application program against the known locations of the tag information allows software manufacturers to trace each pirated copy back to the original authorized user, who is presumptively the unauthorized distributor, so that the appropriate charges and fines can be levied against the unauthorized distributing of pirated software. As noted, this user traceability is also beneficial before the fact as a deterrent to potential hackers tempted to distribute pirated copies of software known to be protected in this manner.

Step 450 is then followed by step 455, in which each piece, e.g. each file or component, of the software of interest is downloaded to the client platform over the encrypted channel. The pieces may then be installed in locations within the memory storage device associated with the client platform in a manner in which the software will operate correctly and/or content will be correctly accessible. In an embodiment of the invention, the software of interest is located in a single contiguous memory location.

For executable content, each time the software application program is executed, the UUI of the client platform is checked with the UUI embedded within the files associated with the software application program, by virtue of the code check embedded in the executable content of interest. If the two UUIs do not match, the software application program terminates. If, however, the two UUIs match, the executable software will execute normally and the UUI check will be transparent to the authorized user. A warning or notification to a user of the unauthorized platform may also be displayed at this point in an embodiment of the invention. Moreover, a certifying or distributing authority or other company or entity may be automatically notified of the attempted access at this point, in an embodiment of the invention. Step 455 is then followed by the “END” step.

Returning to step 435, if the determination is made that the Client Program has previously been executed for download a number of times that is equal to the authorized number of times, such as by checking the flag or counter associated with Client Program stored in the database on the remote server, the “NO” branch is followed to step 460 in which the software application program is terminated. Step 460 is then followed by the “END” step.

FIG. 4C illustrates in flow chart form a process according to an embodiment of the invention for generating and placing user platform information (e.g. UUI) in a file or files for use as discussed above for authorization and/or tracking. Initially, at step 461 the user platform information itself, as discussed above, may be processed to derive a coded user identifier. There are a number of possible techniques usable to code the UUI. The first, alluded to above, is to string the hash user platform information segments and hash them, subsequently concatenating some or all of the hash information. Benefits of this method are that it assures that the coded UUI will almost certainly be unique, based on the extremely low probability of the hash yielding an identical output for different inputs. However, the hash is irreversible to obtain the original user platform information, such as serial numbers. While this is a security benefit, it also limits user flexibility in that it does not allow for any future changes to the user platform with respect to components that were used to derive the A second method for generating the coded UUI is to interleave sections of the UUI to create a unique string. For example, the coded UUI can be selected by taking digits from predetermined positions in the UUI information. Thus, for example, an interleave rule could dictate that the coded UUI should comprise the first and third digits of the OS identifier, the second and fourth digits of the MAC identifier, and the third and fifth digits of the hard drive serial number. Taking specific numbers, assume that the foregoing series of identifiers is 12345567 (OS identifier), 24681012 (MAC identifier), and 13579111315 (hard drive serial number). The coded UUI resulting from the described interleave rule would be 134859. The interleave rule may also dictate the order of these digits, that is they may be interspersed, although the present example assumes a serial array.

A benefit to the second approach is that the coded UUI is reversible by a party having knowledge of the interleave rule used to code the UUI. Thus, allowances can be made for small changes in the client platform, reflected by changes in the digits of particular positions in the coded UUI. For example, a UUI match may be defined as having 70% or more properly located digits in common.

In any case, to further secure the coded UUI in an embodiment of the invention, it may be protected by another key value, such as by being XOR'd with a secret value not generally known outside of the party or parties requiring the protection to the software of interest, be they a seller, manufacturer, or distributor.

Once the coded UUI has been derived, it or another tag is embedded into the content of interest at steps 462-67. In particular, as indicated above, executable files may be treated differently than other content such as media files. At step 462, a file to be tagged is selected. All files of a particular software item of interest may be tagged or rather only certain portions. At step 463, it is determined whether the file to be tagged is media data, or if it is executable content (including non-media data). If the file or component to be tagged is media data, i.e. audio data, image data, or video data, either as part of a program or for a separate player such as the MP3 player noted above, then the process flows to step 465, whereat the tag information is embedded in the media data.

Media data differs generally from other types of data or code in that only perceptual accuracy of the data, rather than absolute numerical accuracy, is required. In an embodiment of the invention, this quality is exploited to place tags in the media data. According to a first technique, pixel values (for image or video data) or sample values (for audio data) within the data are slightly altered to embed the coded UUI or other tag information into the media information. For example, referring to FIG. 5A, an array 500 of pixel data corresponding to a hypothetical grayscale image is shown. Each pixel 501 has a value that defines the desired appearance of that pixel in the displayed image. Although only a small number of pixels are shown in FIGS. 5A-C for the sake of clarity, it will be appreciated that most images comprise a much larger number of pixels or samples.

In order to embed tag information within the pixel data, a plurality of pixel or sample values will be changed in an embodiment of the invention. In particular, each item of content to be tagged is associated with a template or subset of pixel locations. In the illustrated example, the circled values of FIG. 5A represent changed values of pixels selected from the pixels identified by the template (see FIG. 5C) for the UUI of interest. These values have been changed by one increment in the tagged content 501 illustrated in FIG. 5B. In order to further obfuscate the tag information within the content, and hence to increase the security provided by the tagging, noise may be introduced into the tagged content by randomly or otherwise changing the values of a number of pixels that are not used for tagging. In this way, a hacker or other party cannot simply derive the tag locations by comparing the tagged and original files.

When it is desired to check an item of content for embedded user information, the template can be used to identify the pixels that may be used for tagging, and a simple comparison of the pixels in this set with the corresponding pixels in the original content will yield the embedded bit pattern. For example, given the original content of FIG. 5A, the tagged content of FIG. 5B, and the template of FIG. 5C, it can be seen that the embedded value is 11110011 when the templated locations are analyzed in raster order from left to right, top to bottom. It will be appreciated that there are many other specific techniques that could be used both to encode the tag information into the content pixel values and to extract such, and accordingly the given example is intended only for clarification and not limitation.

Although the aforementioned example pertains to grayscale data, the invention is not limited to such. For example, the aforementioned technique may also be used to embed information in color images, whether each pixel is encoded as a mix of colors or rather as a palette value. In the former case, the template may store, in addition to a pixel location, an identification of the color value that will embody the tag. Thus, for example, the red value of the 12^{th} pixel may be changed to embed data, rather than simply the entirety of the pixel of interest as in the grayscale case. With respect to palette encoded color content, this case is similar to the grayscale case in that each pixel's color value is encoded by a single value.

For palette encoded color content, the pixel value provides an index into a palette of colors. In this case, it is less desirable to template in a random fashion. Rather, the data is scanned for a pixel value that appears frequently, and then the set of all or some of the occurrences of that pixel value form the template used to encode or embed the user-identifying tag information. Thus, small changes, such as a unitary increment, in certain members of the set can be detected to retrieve the embedded user information.

Additionally, the aforementioned techniques can also be used for other media types. For example, audio content such as a song or audio clip is similarly comprised of an array or series of samples, which can be selectively altered to embed user information in the data. In this instance as well, it may be desirable to introduce noise as discussed above to obscure the templated locations.

As discussed above, a second technique for embedding user information in media content is to place the information in the header of the content. Depending upon the technique used to perform the embedding in this case, it may be more or less secure than the technique discussed above. Note that media content can be tagged with embedded user information whether that content is self-contained, such as a copy of a song for distribution to MP3 players and the like, or part of a larger whole, such as media files associated with an executable. In the latter case, either or both of the executable content and the media content can be tagged as will be discussed hereinafter.

If at step 463 it is instead determined that the content to be tagged is executable, then another set of techniques can be used in step 467 to tag that content. In general, there are several ways to tag executable content. Executable content differs from media content in two primary ways. First, pseudo-random noise (such as from changing pixel/sample values) cannot be as easily dispersed in executable content as it can in media data, since numerical and character accuracy are more critical. Secondly, executable content more easily lends itself to the insertion of further executable content, such as one or more validation checks.

One way to embed the tag information in an uncompiled executable is to insert it as a variable. For example, the executable content can be pre-prepared with multiple locations to accept the tag information. The appropriate lines can be identified by unique character strings, and the variable location itself filled with placeholder characters. At one or more of these locations, or at another location or locations, a validation check is inserted into the executable. The purpose of the validation check as discussed above is primarily to perform the task of collecting the UUI of the executing platform to check against an embedded instance of the UUI. Note that the UUI may be placed as a contiguous string or may be dispersed in multi-bit segments. In an embodiment of the invention, the UUI and validation check or checks are located in the same place for every instance of a given executable to facilitate use by the manufacturer or authorized party in preventing or detecting unauthorized copying. Moreover, a hash of both the original file and the tagged file may be kept and associated with the template for locating the embedded user information, so that the hash of a suspect item may be used as an index to locate the appropriate templates and so forth.

Another method for tagging executable content entails shifting functions or sections within the executable and then padding the executable. For example, a PE header typically contains a table identifying the addresses of specific routines. The addresses can be altered by shifting, which is also recorded in the table. The executable will still work as intended, and the difference between the altered and unaltered versions of the executable can be used as discussed above to regenerate the embedded information based on whatever code scheme the manufacturer etc. chooses to employ.

In an embodiment, compiled executable content such as a portable executable is tagged by tagging only its associated media, data or other non-executable content in the manner discussed above. Typically, the locations of such program resources are given in a header such as a PE header, but it is also feasible to scan the program to identify non-executable portions.

After the file selected at step 462 is tagged, it is determined at step 469 whether there is another file to be tagged. If it is determined at step 469 that there exists another file to be tagged, then the process flows back to step 463. Otherwise, the process terminates at step 471.

In an embodiment of the invention, it is desirable to place other anti-piracy features into executable content to thwart any attempt at compromising the code check or the tags. For example, an experienced hacker may use a software device known as a debugger to step through and analyze code. With respect to the present invention, a hacker may step through the code using a debugger to try and find the code check and possibly the hidden tags as well. Accordingly, in an embodiment of the invention, a debugger deactivator step or sequence may be placed early in the executable content to thwart successful analysis of the code. Additional responses to use of a debugger on the executable content may include de-installation of the content, notification via email, direct message etc. to a third party such as an enforcement or manufacturing party, and so on. Executable sections such as the debugger detector may be inserted just prior to download by dynamic patching according to an embodiment of the invention, or via any other suitable mechanism.

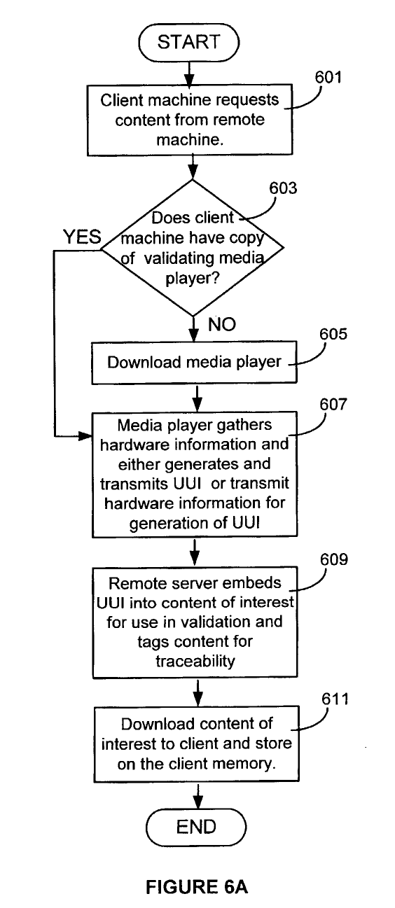

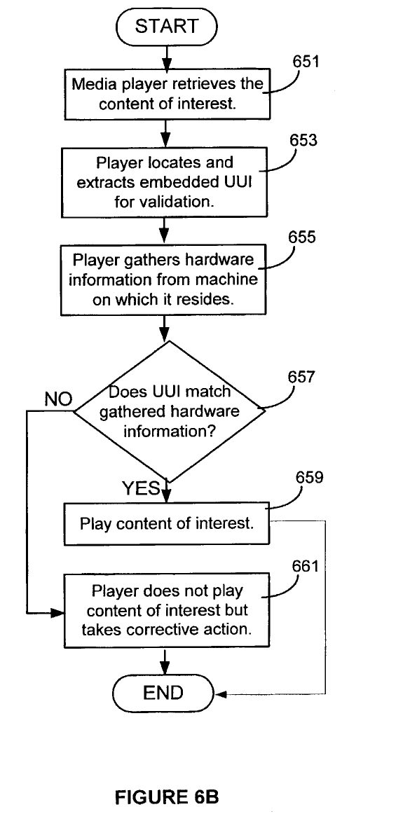

A technique for tagging nonexecutable content for both machine validation and piracy traceability and for accessing such content according to an embodiment of the invention is illustrated in greater detail in FIGS. 6A and 6B and is discussed hereinafter. Nonexecutable content for this discussion as well as the foregoing discussion can comprise any type of digitally represented media content such as graphical material (images, drawings, photographs, etc.), video material (video clips, animation clips, movies, videos, etc.) and audio material (songs, albums, audio clips, sound effects, audio books, etc.) as well as any combinations thereof.

When such nonexecutable content accompanies or is associated with executable content, the executable content may be modified to comprise a validation check as discussed above, and the hardware information or other information required for the check may be embedded in either or both of the nonexecutable content or the associated executable content. However, in the case where such nonexecutable content is distributed without accompanying executable content, the validation check may be performed in a slightly different manner since it is not typically feasible to insert an executable validation check into such materials.

Referring to step 601 of FIG. 6A, a client machine initially requests content from a remote machine such as a server over a network such as the Internet. At step 603, it is determined whether the client machine has a copy of a validating media player, as will be discussed in greater detail hereinafter. If at step 603 it is determined that the client machine does not have a copy of the validating media player, then the process flows to step 605 where the media player is downloaded, and then to step 607. If it is determined at step 603 that the client machine does have a copy of the validating media player, then the process flows directly to step 607. Note that in an alternative embodiment of the invention, a standard media player of any conventional design may be used.

At step 607, the media player (or other entity, such as, for example, when a conventional media player is used) gathers the hardware information of the client machine, and either generates the UUI and transmits that to the remote server or simply transmits the hardware information to the remote server which itself generates the UUI. At step 609, the remote server embeds the UUI, in encoded form or otherwise, as discussed above, into the content of interest for use in validation. At this step, the remote server also preferably tags the content for traceability. As discussed above, the tag information may be the UUI or may be other information, but is typically used only for tracing and not for validation. Finally, at step 611, the tagged content of interest is downloaded to the client in encrypted form or other wise and is stored on the client memory for use.

Note that the remote server referred to in the foregoing example may be a single machine according to an embodiment of the invention, but is preferably rather a machine that acts in conjunction with a another remote machine, such as for storing transactions records, tagging information, etc.

The use of tagged nonexecutable content is illustrated in greater detail via FIG. 6B. In particular, at step 651, the media player retrieves the content of interest, such as pursuant to a selection or prompt from a user. In step 653, the player locates and extracts the embedded UUI for validation. (Note that when a conventional media player is used, a separate entity is preferably employed for this and subsequent client-side steps related to validation or corrective action, although the media player itself may execute the task of actually playing the content of interest.) At step 655, the player gathers hardware information from the machine on which it resides. The UUI and the gathered hardware information are compared at step 657 to determine whether they correspond. This step may require conversion of either the UUI or the hardware information to the appropriate format.

If it is determined at step 657 that the UUI and the hardware information do correspond, then the player proceeds to play the content at step 659. Otherwise, at step 661 the player does not play the content and may instead take any number of corrective actions. Such actions include displaying a warning or advertisement, and/or transmitting a notification of the potential piracy to an appropriate party. In the later case, the content itself may also be transmitted for tracing.

In an embodiment of the invention relating to nonexecutable content, the player is hardware or firmware rather than software, and the installation of the player is by way of an alternative to download. In another alternative embodiment, the content of interest is tagged for tracing only, with validation being omitted. In this case, all tags may be information other client-side hardware-related information. In yet another embodiment, the validation mechanism described above with respect to nonexecutable content can be used to allow access to the content of interest on a select plurality of machines, rather than on a single machine. The mechanism for allowing such may be as described above with respect to executable content.

It will be appreciated that a new and novel system for the protection of downloadable software has been disclosed herein, applicable to executable content, nonexecutable content, and any combination thereof. It should be understood that the foregoing detailed description pertains only to the preferred embodiments of the present invention, and that numerous changes may be made to the embodiments described herein without departing from the spirit and scope of the invention. Accordingly, the invention contemplates all such as embodiments as come literally within the scope of the accompanying claims, as well as equivalents thereof.

We claim:

1. A method of securing downloadable software of interest against unauthorized distribution comprising:
receiving at a server a set of platform data characteristic of an authorized user platform to which the software of interest will be downloaded;
prior to downloading the software of interest, inserting at least one instance of the platform data into the software of interest; and
prior to downloading the software of interest, inserting a validation check into the software of interest, wherein the validation check is adapted to compare one or more of the at least one instance of the platform data with platform characterizing information of an executing platform to determine whether the executing platform is the authorized user platform to which the software of interest has been downloaded.

2. The method according to claim 1, further comprising inserting prior to downloading the software of interest at least one tag into the software of interest, wherein the at least one tag is not associated with or used by the validation check.

3. The method according to claim 1, wherein the data characteristic of the user-platform comprises one or more identifiers selected from the group consisting of user platform files, user platform software, and user platform hardware.

4. The method according to claim 2, wherein the software of interest comprises executable content, and wherein the steps of inserting at least one instance of the platform data into the software of interest and inserting at least one tag into the software of interest each comprise encoding via shifting one or more segments within the executable content.

5. The method according to claim 2, wherein the software of interest comprises executable content, and wherein the steps of inserting at least one instance of the platform data into the software of interest and inserting at least one tag into the software of interest comprise inserting the platform data and the tag respectively into the executable content as at least one program variable.

6. The method according to claim 1, wherein the software of interest comprises non-executable content, and wherein the step of inserting at least one tag into the software of interest comprises selectively modifying data values within the nonexecutable content, whereby the pattern of modified data values encodes the tag.

7. The method according to claim 6, wherein the non-executable content comprises image information, and wherein the data values modified comprise pixel values.

8. The method according to claim 6, wherein the non-executable content comprises audio information, and wherein the data values modified comprise sample values.

9. The method according to claim 6, further comprising the step of modifying data values other than those used to encode the tag in order to hide the pattern of modified values used to encode the tag.

10. The method according to claim 1, wherein the software of interest comprises non-executable content, and wherein the step of inserting at least one instance of the platform data into the software of interest comprises selectively modifying a header of the non-executable content to encode the platform data therein.

11. A computer-readable medium having thereon computer-readable instructions for performing the method of claim 1.

12. A computer-readable medium having thereon computer-readable instructions for performing the method of claim 4.

13. A computer-readable medium having thereon computer-readable instructions for performing the method of claim 5.

14. A computer-readable medium having thereon computer-readable instructions for performing the method of claim 6.

15. A method of protecting downloadable software from unauthorized distribution comprising:
receiving platform-identifying information from a downloading platform; and
dynamically embedding the platform-identifying information into the downloadable software prior to download to the downloading platform.

16. The method according to claim 15, further comprising embedding a validation check into the downloadable software prior to download to the downloading platform, wherein the validation check is adapted to execute during attempted execution of the downloadable software, and thereby to compare the embedded platform-identifying information with platform-identifying information derived from the executing platform.

17. The method according to claim 16, wherein the validation check is further adapted to take a preventive action if the embedded platform-identifying information is not the same as the platform-identifying information derived from the executing platform.

18. The method according to claim 17, wherein the preventive action comprises at least one action selected from the group of actions consisting of preventing execution of the downloadable software, transmitting a notification of unauthorized access, presenting a notice to a user of the executing platform, and playing an advertisement.

19. A computer-readable medium having thereon computer-readable instructions for performing the method of claim 15.

20. A computer-readable medium having thereon computer-readable instructions for performing the method of claim 16.

21. A method of securely providing downloadable nonexecutable content to a client machine from a server machine over a network comprising:
receiving over the network a request from the client machine for the downloadable nonexecutable content;
determining whether the client machine has a copy of a validating media player and downloading a copy of the validating media player to the client machine if it is determined that the client machine does not have a copy of the validating media player;
receiving machine-specific information from the client, wherein the machine-specific information is associated with the client machine;
embedding a representation of the machine-specific information into the downloadable nonexecutable content for use in later associating a specific client machine with a specific download of the downloadable nonexecutable content;
embedding at least one tag into the downloadable nonexecutable content for use in later associating a specific client machine with a specific download of the downloadable nonexecutable content; and
downloading the downloadable nonexecutable content to the client machine.

22. The method according to claim 21, wherein the at least one tag comprises user-specific information.

23. The method according to claim 22, wherein the user-specific information comprises a credit card number.

24. The method according to claim 22, wherein the user-specific information comprises a look-up number usable to look up user-identifying information.

25. The method according to claim 24, wherein the user-identifying information comprises an identity of a user of the client machine.
